(19) United States
(12) Patent Application Publication
(10) Pub. No.: US 2003/0218577 A1
(43) Pub. Date: Nov. 27, 2003

(54) Laptop computer with a large display area

(76) Inventor: Bruce Yunlong Wang, Irvine, CA (US)

Correspondence Address: PRICE and GESS, Suite 250, 2100 S.E. Main Street, Irvine, CA, 92614, US

(21) Appl. No.: 10/153,091

(22) Filed: May 22, 2002

(51) Int. Cl. G09G 5/00

(52) U.S. Cl. 345/1.3

(57) ABSTRACT

The present invention is a laptop computer having three screens extending upward from a computer base for providing a large combined display area, wherein the three screens can be stacked in a compact manner for portable storage. The laptop computer includes a computer base, and a center screen rotatably connected to the top of the computer base. A left and right pole are rotatably connected to the top of the computer base on opposite sides of the center screen. A left and right screen are rotatably connected to the left and right pole, respectively. In an operative mode, the center, left and right screen are rotated to extend upward from the computer base to provide a large combined display area. In a storage mode, the center, left and right screen are rotated to be stacked above the computer base to provide compact storage and easy transport of the laptop computer.

### TECHNICAL FIELD

The present invention relates to a laptop computer including a plurality of screens that can be arranged for displaying information to a user and/or third parties in an operative mode, wherein the plurality of screens can be stacked in a compact manner for portable storage of the laptop computer.

### BACKGROUND ART

A conventional laptop computer generally comprises a screen rotatably connected to a computer base with an attached keyboard. When in operation, the screen is usually rotated to extend upward from the computer base for displaying information directly to the user in front of the keyboard. When not in operation, the screen is rotated down on top of the computer base for storage and transport of the laptop computer.

A problem with many conventional laptops is that the display area of the screen is restricted by the width and length dimensions of the computer base. This may limit the amount of information that can be displayed to the user at any one time. This is especially troublesome when the user wishes to view information content that is too large for a single screen. This requires the user to scroll the information down the screen, display the information in segments one at a time on the screen or compress the size of the information to fit onto the screen which can strain the user's eyes.

Additionally, the laptops are frequently used as a sales tool and/or demonstration display to provide information to third parties and therefore suffer from limited display space.

The prior art has disclosed multiple display screens such as U.S. Pat. No. 5,467,102, U.S. Pat. No. 5,590,021, U.S. Pat. No. 5,784,035, U.S. Pat. No. 5,534,888, U.S. Pat. No. 5,416,666, U.S. Pat. No. 5,796,577, U.S. Pat. No. 5,128,662, Japanese Laid Open Patent No. 4-261,579 and Japanese Laid Open Patent No. 1-293387.

Therefore, there is a need to increase the display area of a laptop computer, while not sacrificing the compactness of the laptop computer when not in operation. In addition, there is a need for an economical laptop computer having a combined display area that is not restricted by the width and length dimensions of the computer base and which can be operatively arranged in various configurations to provide display information to both the user and third parties.

### SUMMARY OF THE INVENTION

The laptop computer of the present invention addresses the above problems by providing a plurality of display screens such as three screens for displaying information to the user, while maintaining the compactness of the laptop computer in a storage mode by safely stacking the three screens.

Specifically, the laptop computer of the present invention includes a computer base and an appendant center screen rotatably connected to the top of the computer base. A left and right support member or pole are rotatably connected at one end to the top of the computer base on opposite sides of the center screen. A left and right display screen are rotatably connected to the left and right pole, respectively. In an operative mode, the center, left and right screens are rotated to extend upward from the computer base providing a large combined display area. In a storage mode, the center, left and right screen are rotated to be stacked above the computer base providing compact storage and easy transportation of the laptop computer.

### BRIEF DESCRIPTION OF THE DRAWINGS

The exact nature of this invention will be readily apparent from consideration of the following detailed description in conjunction with the accompanying drawings, wherein:

FIG. 1 shows a perspective view of the laptop computer of the present invention in an operational configuration;

FIG. 2 shows the laptop computer of the present invention being configured from the operation configuration to a storage configuration;

FIG. 3 shows the laptop computer of the present invention being configured from the operational configuration to the storage configuration at a later stage than FIG. 2;

FIG. 4 shows the laptop computer of the present invention in the storage configuration with a protective cover being placed over the laptop computer;

FIGS. 5a and 5b show exploded views of the connection between the right pole and the top of the computer base of the present invention;

FIG. 6 shows a perspective view of the back of the laptop computer of the present invention in the operational configuration; and

FIG. 7 shows a perspective view of the back of the laptop computer of the present invention in the operational configuration connected by a bus to another laptop computer.

### DETAILED DESCRIPTION OF THE PREFERRED EMBODIMENT

The following description is provided to enable any person skilled in the art to make and use the invention and sets forth the best modes contemplated by the inventors of carrying out their invention.

FIG. 1 shows the laptop computer of the present invention in an operational configuration. The laptop computer comprises a computer base 1 with an attached keyboard 21 and screen controls 17, 19 on a top portion of the base 1. A center screen 3 is rotatably connected to the top of the computer base 1, near the back side of the computer base 1, for example by a conventional pivotal hinge. In the operational configuration, the center screen 3 is rotated to extend upward from the top of the computer base 1. A right connecting pole 5 and a left connecting pole 11 are each rotatably connected at one end to the top of the computer base 1, such that the poles are on opposite sides of the center screen 3. Each pole bends to form a right angle and rotates about an axis perpendicular to the top of the computer base 1. The bend of the right pole 5 is at a higher height above the top of the computer base than the bend of the left pole 11. The reason for this will be explained later. A right screen 7 is rotatably connected to the other end of the right pole 5 and a left screen 13 is rotably connected to the other end of the left pole 11. Each screen has a pole channel 23, 25 for rotatably connecting the screen to the corresponding pole by inserting the pole into the channel. In the operational configuration, the right 7 and left 13 screen are rotated to extend upward from the top of the computer base 1 on opposite sides of the center screen 3, providing a large combined display area on three screens. The right 7 and left 13 screen are each supported at one end by their corresponding pole. The right 7 and left 13 screen each include a retractable stand 9, 15 for supporting the other end of the screen on a flat surface.

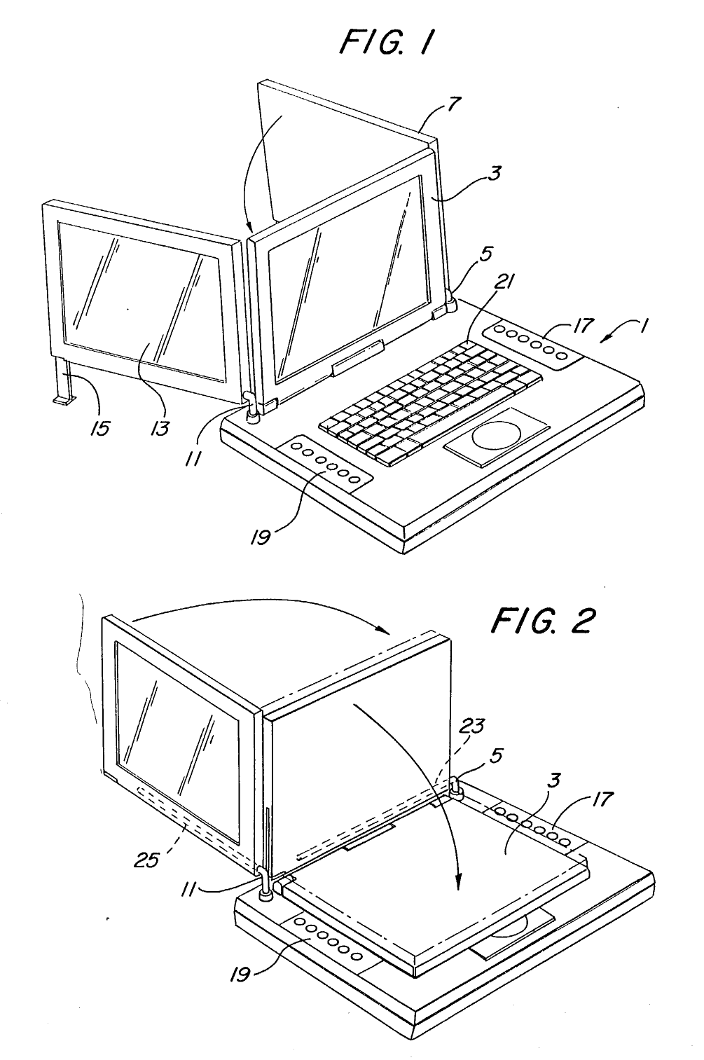

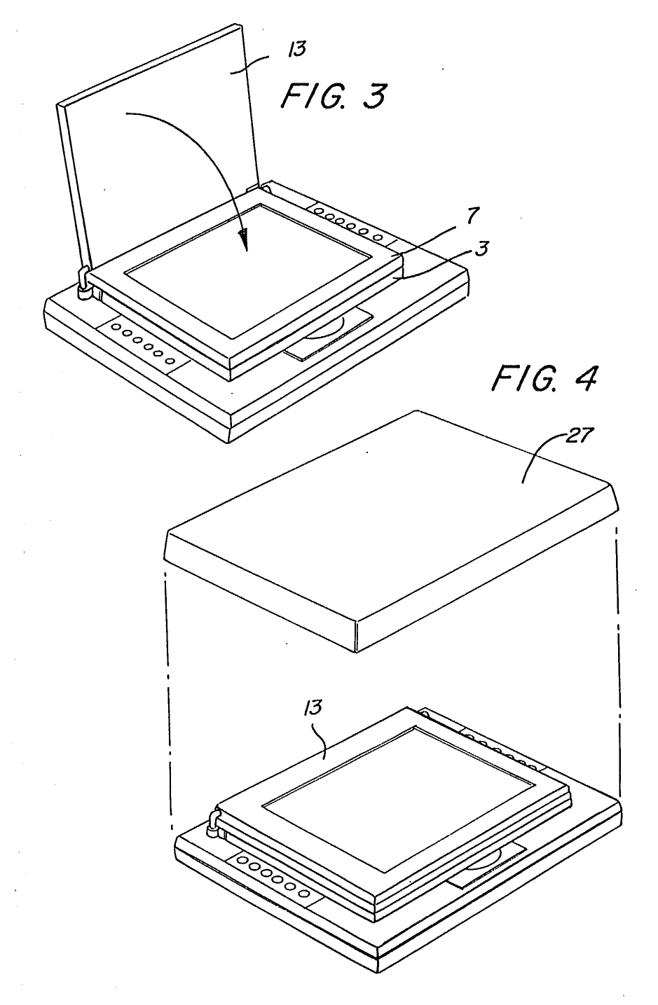

FIG. 2 shows the laptop computer of the present invention being configured into a storage configuration. The center screen 3 is rotated down on top of the computer base 1. The left screen 13 is rotated from its position in FIG. 1 to a position at which the left screen 13 runs parallel to the left side of the computer base 1. Similarly, the right screen 7 is rotated from its position in FIG. 1 to a position at which the right screen 7 runs parallel to the right side of the computer base 1. Both screens are rotated by rotating about their respective poles and the poles revolve within the receptacles in the computer base.

FIG. 3 shows the laptop computer of the present invention being configured into the storage configuration at a later stage than FIG. 2. The right screen 7 is rotated down from its position in FIG. 2 on top of the center screen 3 by rotating the right screen 7 about the right pole 5. Similarly, the left screen 13 is rotated down on top of the left screen by rotating the left screen 13 about the left pole 11. The bend of the left pole is at a higher height above the computer base than the bend of the right pole so that the left screen 13 can be stacked on top of the right screen 7.

FIG. 4 shows a protective cover 27 being placed over the screens and the top of the computer base 1 for holding the screens in place during transport of the laptop computer. The cover 27 has a height sufficient to house the screens when they are stacked.

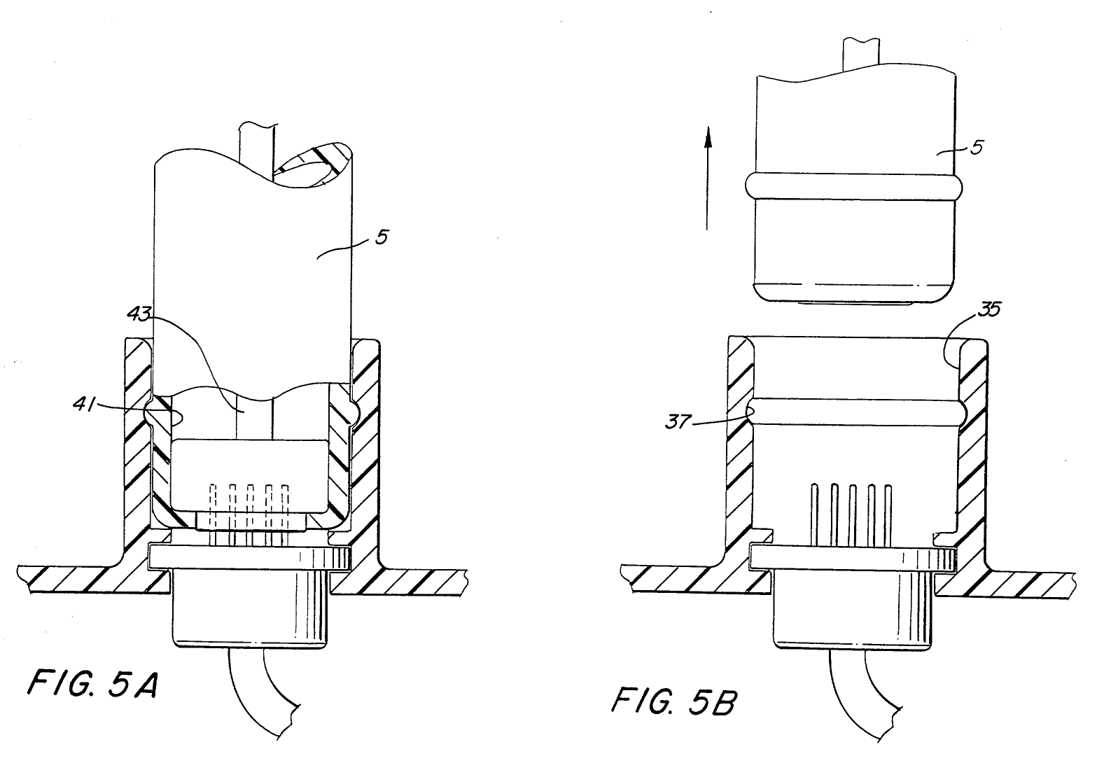

FIGS. 5A and 5B show a detailed view of the connection between the right pole 5 and the top of the computer base 1. The connection shown in FIG. 5 is the same between the left pole and the computer base. The computer base includes a pole slot 35 for connecting the right pole 5 to the computer base by inserting the right pole 5 into the pole slot 35. The right pole 5 includes a notch 37 and the pole slot 35 includes a notch groove 39 engaging the notch 37 for securing the right pole 5 to the pole slot 35. The pole 5 includes an inner channel 41 for running a screen control cable 43 therethrough to electrically connect the right screen to the computer base 1.

The computer base also includes two sets of screen control buttons 17, 19 on opposite sides of the keyboard 21, as shown in FIG. 1. The set of buttons to the right 17 of the keyboard 21 control the content of the right screen 7 and the set of buttons to the left 19 of the keyboard 21 control the content of the left screen 11. The right set of buttons 17 includes a button for swapping the content on the right screen with the left screen, a button for extending the content on the right screen to the center screen, a button for extending the content on the center screen to the right screen, a button for extending the content on the right screen to the center and left screen, a button for swapping the content on the right screen with the center screen, and a button for copying the content on the center screen to the right screen. The left set of buttons 19 includes the same buttons as the right set of buttons with the right and left screen interchanged. Therefore, the right and left set of buttons give the user flexibility in arranging the content displayed on the screens. One skilled in the art will appreciate that the screen control functions of the two sets of buttons can be accomplished with one set of buttons and a special function button. In this case, the special function button is used to switch the set of buttons between controlling the content on the right and left screen.

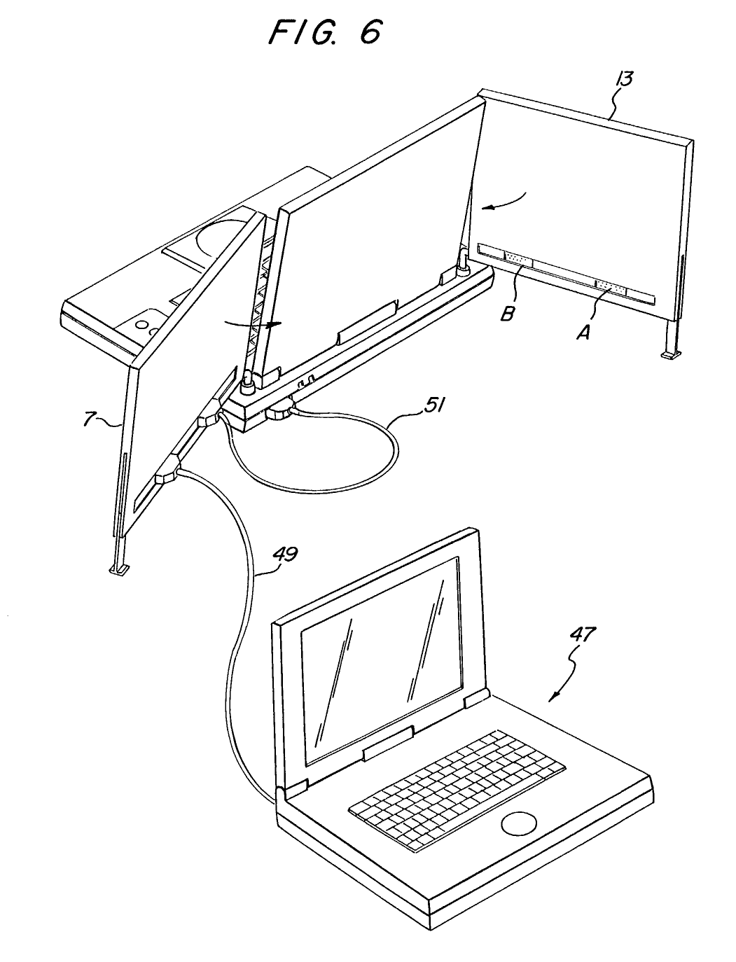

FIG. 6 shows the back of the laptop computer of the present invention in the operational configuration. The left 13 or right 7 screen can be rotated to a position at which the left 13 or right 7 screen is back to back with the center screen 3 by rotating the poles connected to the screen. This is indicated on FIG. 6 by the arrows pointing from the back of the left 13 and right 7 screen to the back of the center screen 3. Therefore, when the laptop computer is placed between a user in front of the keyboard and a third party facing the user, the left 13 or right 7 screen can be positioned in front of the third party. The advantage of positioning the left 13 or right 7 screen in front of the third party is that it allows the user to easily share displayed information with the third party. In addition, the user can display the same information on a screen facing the user and on a screen facing the third party using the screen control buttons. That way, both the user and the third party can easily refer to the same information.

The back of the right screen includes two external screen inputs A and B, as shown in FIG. 6. One of the external screen inputs A can be connected to another laptop computer 47 through a cable 49 for receiving display information from the other laptop computer 47. The other external input B can be connected to a back panel outlet 45 on the back of the computer base 1 for receiving display information from the computer base 1 through an external cable 51.

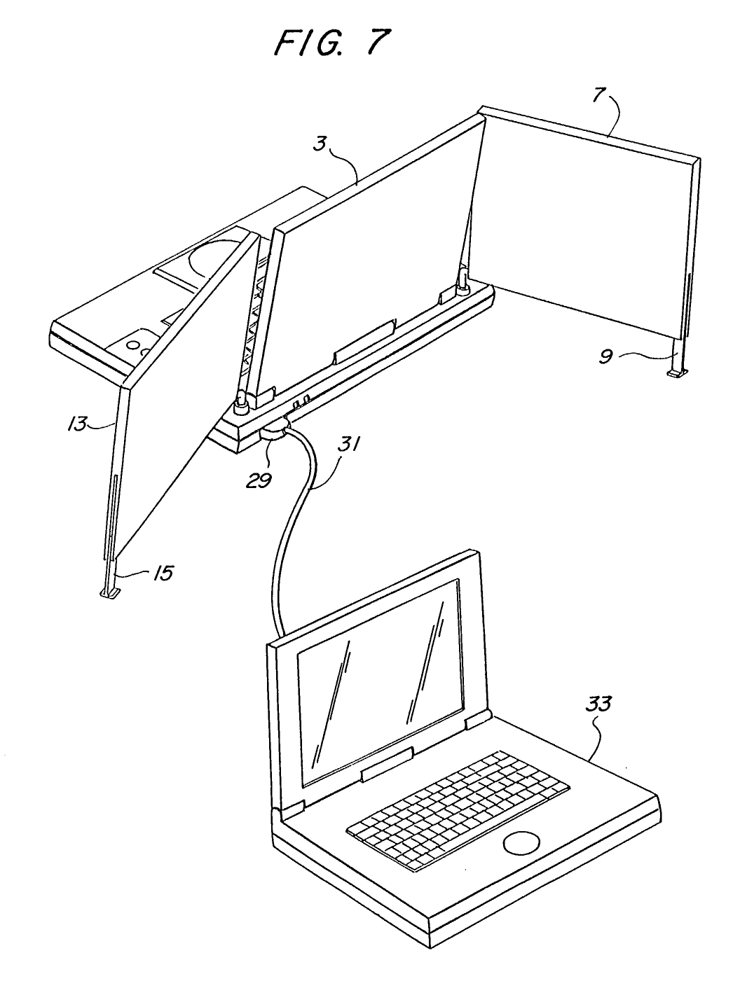

FIG. 7 shows the back of the computer base including a bus outlet 29 for connecting the laptop computer of the present invention to an external bus cable 31. The other end of the external bus cable 31 can be connected to another laptop computer 33 to provide a link between the laptop computer of the present invention and the other laptop computer 33.

Those skilled in the art will appreciate that various adaptations and modifications of the just-described preferred embodiment of the invention can be configured without departing from the scope and spirit of the invention. Therefore, it is to be understood that, within the scope of the appended claims, the invention may be practiced other than as specifically described herein.

What is claimed is:

1. A laptop computer, comprising:
a computer base;
a first pole rotatably connected at one end to the top of the computer base;
a first screen rotatably connected to the other end of the first pole and capable of extending upward from the computer base;
a second pole rotatably connected at one end to the top of the computer base;
a second screen rotatably connected to the other end of the second pole and capable of extending upward from the computer base; and
a third screen rotatably connected to the computer base and capable of extending upward from the computer base, whereby in an operative mode, the first, second, and third are rotated to a position above the computer base for viewing, and in a storage mode, the first, second and third screen are rotated to be stacked above the computer base.

2. The laptop computer of claim 1, wherein the first and second pole rotate about an axis perpendicular to the top of the computer base and the first and second screen rotate about their respective poles such that first and second screen can be horizontally stacked on top of the computer base.

3. The laptop computer of claim 2, wherein the first or second pole can be rotated to a position at which the screen connected to the pole is back to back with the third screen.

4. The laptop computer of claim 3, wherein the third screen and the screen back to back with the third screen display the same information.

5. The laptop computer of claim 1, wherein the first and second screen each have a connecting channel for rotatably connecting the screen by inserting the end of the pole connected to the screen into the connecting channel.

6. The laptop computer of claim 1, wherein the computer base has a first and second pole slot for rotatably connecting the first and second pole to the computer base, respectively, by inserting the end of each pole connected to the computer base into the corresponding pole slot.

7. The laptop computer of claim 6, wherein the end of each pole connected to the computer base has a locking notch and each pole slot has a notch groove engaging the corresponding locking notch.

8. The laptop computer of claim 1, wherein the first and second screen each have a retractable stand for supporting the screen on a flat surface.

9. The laptop computer of claim 1, wherein each pole has an inner channel for running a cable therethrough to electrically connect the screen to the computer base.

10. The laptop computer of claim 1, wherein the computer base has screen control buttons for controlling the content displayed on the screens.

11. The laptop computer of claim 10, wherein the screen control buttons include buttons for swamping the content displayed on one screen with the content displayed on another screen.

12. The laptop computer of claim 10, wherein the screen control buttons include a button for extending the content displayed on the first screen to the third screen and a button for extending the content displayed on the second screen to the third screen.

13. The laptop computer of claim 10, wherein the screen control buttons include a button for copying the content displayed on the third screen to the first screen and a button for copying the content displayed on the third screen to the second screen.

14. The laptop computer of claim 1, wherein the first and second pole each bend to form a substantially right angle.

15. The laptop computer of claim 14, wherein the bend of the second pole is at a higher height above the top of the computer base than the bend of the first pole so that the second screen can be stacked above the first screen.

16. The laptop computer of claim 1, wherein the back of the first or second screen includes an external screen input for receiving display information from another computer.
